(19) United States
(12) Patent Application Publication
(10) Pub. No.: US 2016/0207742 A1
(43) Pub. Date: Jul. 21, 2016

(54) LIFTING DEVICE, SYSTEM, AND METHOD

(71) Applicant: Timothy Craig Schlothauer, Mechanicsville, VA (US)

(72) Inventor: Timothy Craig Schlothauer, Mechanicsville, VA (US)

(21) Appl. No.: 14/987,920

(22) Filed: Jan. 5, 2016

Related U.S. Application Data
(60) Provisional application No. 62/103,734, filed on Jan. 15, 2015.
(60) Provisional application No. 62/235,163, filed on Sep. 30, 2015.

(51) Int. Cl. B66C 1/18

(52) U.S. Cl. CPC B66C 1/18

(57) ABSTRACT

A lifting device comprises a central loop, first and second opposing lifting eyes, and first and second opposing chokers slidably engaged with the central loop. The central loop comprises first and second opposing straps. Each strap has first and second ends. The first end of the first strap is joined to the first end of the second strap forming a first end of the central loop. The second end of the first strap is joined to the second end of the second strap forming a second end of the central loop. The first lifting eye is at the first end of the central loop and the second lifting eye is at the second end of the central loop. The chokers are each slidably engaged with the first and second opposing straps and selectively slidable in relation to the first and second opposing straps. The chokers are independently slidable.

### CROSS-REFERENCE TO RELATED APPLICATIONS

This application claims priority to U.S. Provisional Application Ser. No. 62/103,734, filed Jan. 15, 2015 and U.S. Provisional Application Ser. No. 62/235,163, filed Sep. 30, 2015, the contents of which are incorporated herein by reference in their entirety.

### FIELD OF THE INVENTION

The present invention relates generally to devices and methods for lifting, and more particularly to devices and methods for lifting irregularly sized and/or shaped objects.

### BACKGROUND

The movement of irregularly sized and/or shaped objects, especially large and/or heavy objects (e.g., rocks/boulders) is difficult due to both the irregularity of shape and the variance in weight. The methods currently employed include forked machines occasionally in combination with chains, straps, ropes, etc., and other hydraulically powered mechanical devices such as clamps, pinchers, and other scissor-like devices. The limitation of these devices includes bottom side access for both picking up and depositing the object (i.e., placing some part of a lifting device under the object may be difficult or impossible), damage to the object, mechanical failure, relative dimensional scaling, retraction after depositing, and limited positioning capabilities. Furthermore, these solutions can be quite costly.

With the proliferation of construction involving large rocks and boulders, it has become apparent that the industry needs a solution for safely lifting and placing large, irregularly sized object that can be adapted to current machinery. In most cases, manpower is being used to manipulate objects that are clearly beyond the lifting and moving capacity of man and which places them in extreme danger. The danger is increased when non-engineered solutions are employed and loads are suspended above people and other sensitive objects.

It is known to try to move large, irregularly sized objects with simple, chains, slings, or roped affixed to the object and to the forks, bucket, or other connection point of a machine, such as a fork truck. However, simple slings, straps, ropes, and chains are not engineered to conform to the irregular size and surfaces of the object, making the use of these items dangerous.

The use and rigging of these solutions which are not specifically engineered for this function places people in harm's way and subjects them to potential injuries to hands, feet, backs, shoulders, etc., and potentially death due to crush injuries. Furthermore, damage to the objects regularly occurs, either in the lifting function or when the objects are dropped due to the failure of the devices.

### BRIEF SUMMARY

In one embodiment of the invention, a lifting device comprises a central loop, first and second opposing lifting eyes, and first and second opposing chokers slidably engaged with the central loop. The central loop comprises first and second opposing straps. Each strap has first and second ends. The first end of the first strap is joined to the first end of the second strap forming a first end of the central loop. The second end of the first strap is joined to the second end of the second strap forming a second end of the central loop. The first lifting eye is at the first end of the central loop and the second lifting eye is at the second end of the central loop. The first choker is slidably engaged with the first and second opposing straps and selectively slidable in relation to the first and second opposing straps. The second choker is slidably engaged with the first and second opposing straps and selectively slidable in relation to the first and second opposing straps. The first and second chokers are independently slidable.

The first opposing choker may comprise a single loop slidably engaged with both the first and second opposing straps. The second opposing choker may comprise a single loop slidably engaged with both the first and second opposing straps.

The first opposing choker may comprise first and second loops. The first loop may be slidably engaged with the first opposing strap and the second loop may be slidably engaged with the second opposing strap. The second opposing choker may comprise first and second loops. The first loop may be slidably engaged with the first opposing strap and the second loop may be slidably engaged with the second opposing strap.

The first opposing strap may comprise separate first and second strap portions, each of the first and second strap portions having a free end. The lifting device may further comprise a selective coupling mechanism for selectively coupling the free end of the first strap portion to the free end of the second strap portion.

The selective coupling mechanism may comprise a hook affixed to the free end of the first strap portion and a ring affixed to the free end of the second strap portion.

The free end of the second strap portion may comprise a loop. The selective coupling mechanism may comprise a hook affixed to the free end of the first strap portion.

The free end of the first strap portion may comprise a loop and the free end of the second strap portion may comprise a loop. The selective coupling mechanism may comprise an S-hook.

In addition to the lifting device, as described above, other aspects of the present invention are directed to corresponding methods of lifting an object.

### BRIEF DESCRIPTION OF THE SEVERAL VIEWS OF THE DRAWING(S)

Reference is made herein to the accompanying drawings, which are not necessarily drawn to scale, and wherein:

FIG. 1 illustrates a lifting device in an open/loading position, in accordance with an embodiment of the invention.

FIG. 2 illustrates the lifting device of FIG. 1 in a closed/lifting position.

FIG. 3 illustrates the lifting device of FIGS. 1 and 2 in use.

FIG. 4 illustrates a lifting device in an open/loading position, in accordance with an alternative embodiment of the invention.

FIG. 5 illustrates the lifting device of FIG. 3 in a closed/lifting position.

FIG. 6 illustrates the lifting device of FIGS. 4 and 5 in use.

### DETAILED DESCRIPTION

Embodiments of the invention provide a lifting device, system, and method for lifting irregularly shaped items, especially large and/or heavy items, such as rocks and boulders. Alternative embodiments of the invention provide a lifting device, system, and method for lifting other irregularly shaped items, especially trees with intact root balls.

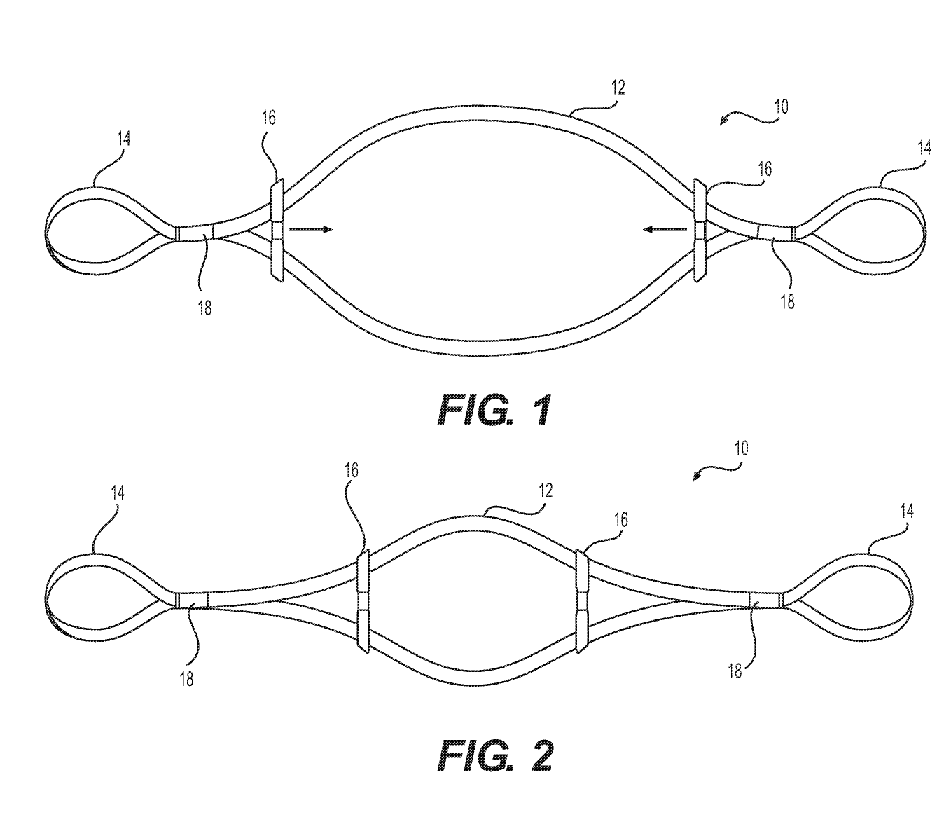

Referring now to FIGS. 1-3, in one embodiment of the invention, the lifting device 10 comprises a center loop 12 (the center loop may be considered to comprise opposing lifting straps, as illustrated), opposing side attachment points 14, and tightening elements 16. The side attachment points 14 may comprise loops (typically much smaller than the center loop), but may alternatively comprise any suitable means of attaching the device to a machine, such as hooks. In the illustrated embodiment, the device comprises one continuous lifting device with a lifting loop or eye at each end, configured such that the device creates two lifting straps. The two lifting straps are then coupled at each end, but inside of the lifting eyes, by the tightening elements, thereby allowing the system to be tightened around the irregularly sized object when lifted. This creates a carrying loop or basket around the outmost, underside edges of the object. This configuration allows for both deployment and retraction of the lifting device while not having to manipulate (lift or move) the object to gain clearance. This lifting device 10 also allows for adjustment of the object on a horizontal plane to aid in final placement of the object.

The lifting device tightens the lifting straps around the irregularly sized objects as weight is engaged due to the tightening elements 16 at each end of the object. The tightening elements 16 allow the device to be scaled to the size of the object. The device then easily disengages the object when weight is disengaged and the system can be easily removed.

The device may be constructed of any suitably strong, flexible, durable, and abrasion-resistant fabric (natural or synthetic), including but not limited to nylon, Kevlar®, or canvas, or combinations or blends of these and/or other materials. In one embodiment of the invention, the device may be constructed of 2″ wide nylon strapping with a 14,700 pound breaking strength (however, any suitable material in any suitable width may be used). The material may be doubled (or even tripled) for added strength, with the layers sewn together along some or all of the length of the device. The center loop and the opposing side attachment points may be constructed of the same material, or different materials. The center loop and the opposing side attachment points may be constructed of a single unitary piece of material, with stitching at transition points 18 to form the separate loops and to secure the ends of the single piece of material. Alternatively, the two lifting straps and/or the opposing side attachment points may be constructed of separate pieces of material, again with stitching at transition points 18 to form the separate loops and to secure the ends of the pieces of material.

A portion of each of the lifting straps and/or a portion of each of the opposing side attachment points may be affixed to or surrounded by a reinforcing material. The reinforcing material may be constructed of a suitably strong, durable, and abrasion-resistant fabric (natural or synthetic), including but not limited to nylon, Kevlar®, or canvas, or combinations or blends of these and/or other materials. The reinforcing material may be affixed to only one side of the portion of each of the lifting straps and/or the portion of each of the opposing side attachment points, or the reinforcing material may be in the form of a sleeve that surrounds the portion of each of the lifting straps and/or the portion of each of the opposing side attachment points. In an embodiment of the invention in which the reinforcing material is in the form of a sleeve, the sleeve is constructed of 1000 denier Cordura® nylon that is doubled for additional abrasion resistance and sewn with a three inch overlap into an elongated sleeve.

The tightening elements 16 may be slide chokers that are slidably engaged with the lifting straps of the center loop. The slide chokers may comprise a single loop that wraps around both lifting straps. Alternatively (as illustrated), the slide chokers may comprise two separate but connected loops, with each loop of the slide choker engaging a separate one of the lifting straps. Even if the slide choker comprises two separate loops, the slide choker may be constructed of a single, unitary piece of material, with stitching at the center to form the separate loops and to secure the ends of the single piece of material.

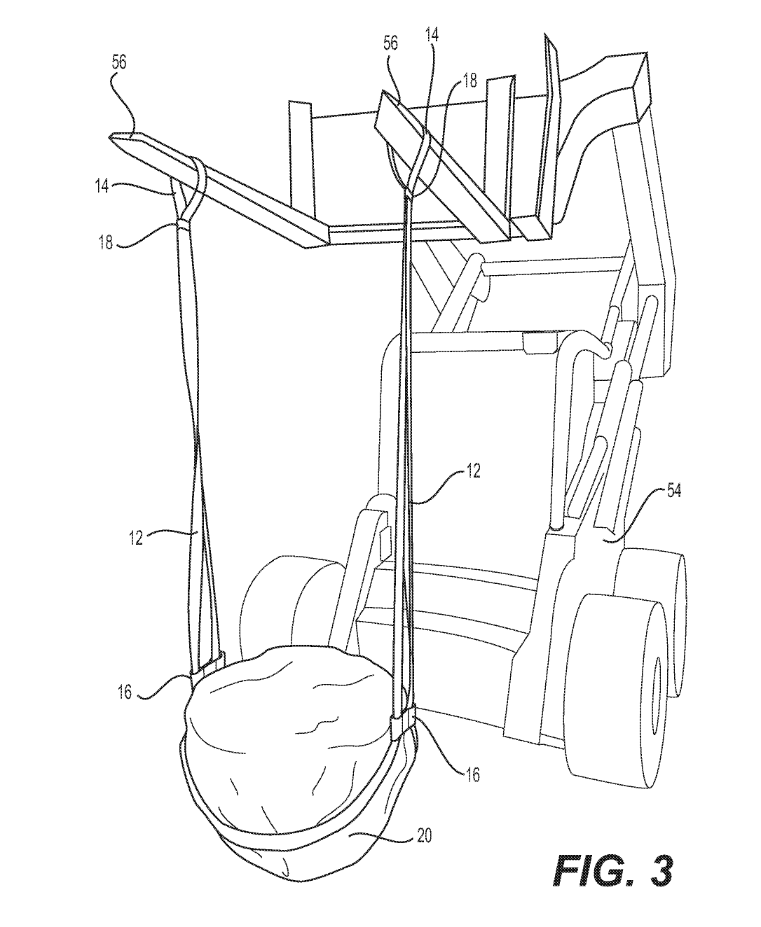

Deployment of the lifting device will occur by placing the lifting eyes of the lifting strap onto the connection point(s) of a machine, such as a fork truck, crane, or the like. FIG. 3 illustrates the lifting device 10 used to lift a boulder 20 via the forks 56 of a fork truck 54. The lifting straps, with the chokers fully extended toward the lifting eyes (or at least extended enough to enable the lifting straps to be placed around the object to be lifted), may be placed around the object and under the outside edges of the object. The chokers will then be moved toward the object (typically placed as close to the object as possible without using any mechanical aids), tightening the lifting straps firmly against the object and engaging the lifting straps and chokers with the underside, outside edges of the object. Lifting the machine's lifting device will engage and firmly tighten the lifting device around the object allowing it to be moved and placed.

After placement, lowering the machine's lifting device and the system will release tension from the object. Slide the lifting strap chokers back toward the lifting eyes and disengage the lifting straps from the object.

In addition to lifting boulders and similar objects, there is also a need for a device to lift trees for planting or transplanting. Such trees are removed from the ground with the root ball intact. The root ball may be quite large and heavy. To prevent damage to the tree, it is necessary to lift the tree by the root ball. The above-described embodiments of the invention work well for lifting boulders and similar objects. However, the above-described embodiments of the invention are less well suited for lifting trees. The height of the tree, as well as the size of the tree canopy, provide a vertical obstruction that can make it difficult to put the above-described device into position around the root ball.

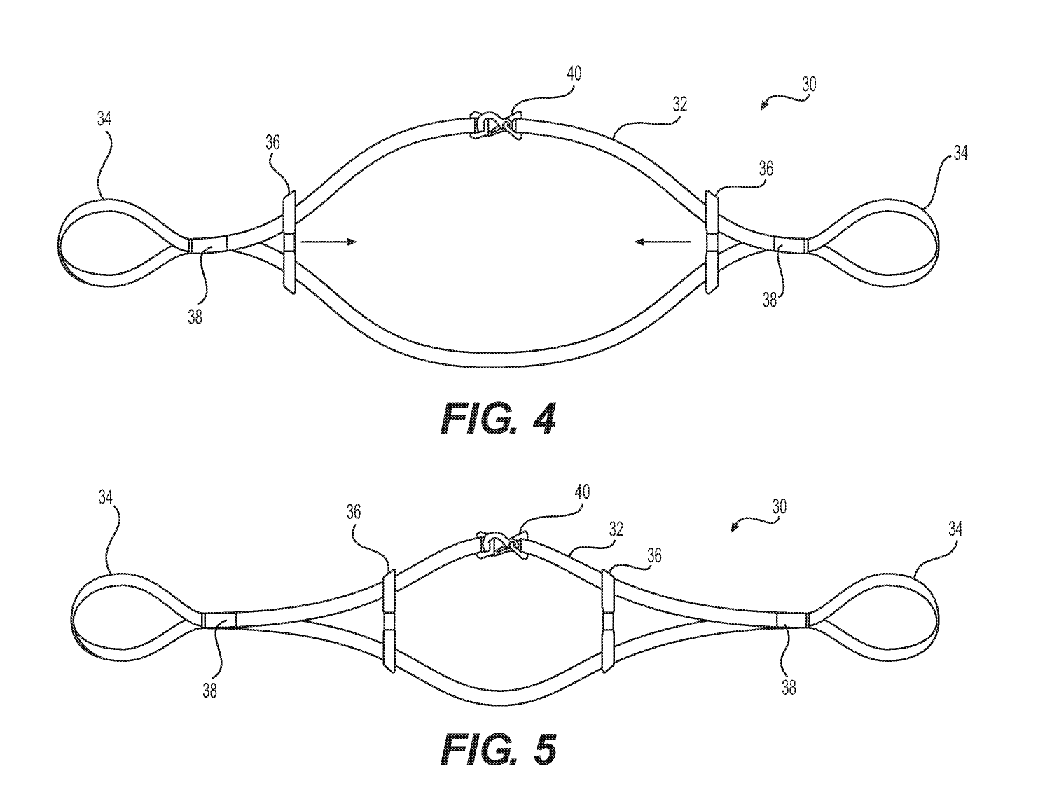

In alternative embodiments of the invention, illustrated in FIGS. 4-6, at least one of the opposing lifting straps of the center loop is modified to have a selective coupling mechanism. (The selective coupling mechanism could be included on both opposing lifting straps of the center loop, but this is not necessary and therefore would add unneeded cost to the device.) The selective coupling mechanism is preferably located at or near the midpoint of the lifting strap, as that location prevents the selective coupling mechanism from interfering with the tightening elements. The selective coupling mechanism enables the respective lifting strap of the center loop to be de-coupled (i.e., split into two sections), which enables the center loop to be positioned around the root ball without interference from the tree. Once the center loop is in position around the root ball, the two sections of the respective lifting strap are then coupled together again via the selective coupling mechanism and the tree may be then be lifted and moved as described above. Once the lifting/moving is done, the two sections of the respective lifting strap are then decoupled via the selective coupling mechanism so the lifting device may be removed.

The selective coupling mechanism may comprise any suitable coupling mechanism (e.g., buckle, latch, hook, etc.) that is strong, durable, and easily coupled/decoupled. The selective coupling mechanism may be constructed out of any suitable material or combination of materials, but may preferably be constructed of metal for strength and durability. In one exemplary embodiment of the invention, as illustrated in FIGS. 4-6, the selective coupling mechanism comprises a stamped D-ring that is attached to the distal end of one of the sections of the lifting strap and a snap hook with D-ring that is attached to the distal end of the other one of the sections of the lifting strap. Each D-ring may be affixed to a loop formed in the respective distal end of the lifting strap. To attach each D-ring, a respective distal end is threaded through the D-ring, folded back onto itself, and stitched into a loop. In another example of the invention, the selective coupling mechanism comprises a loop on one end (the loop may comprise the lifting strap folded back onto itself and stitched into a loop) and a hook on the opposing end (the hook will typically be a metal hook, and may have a spring latch). In yet another example of the invention, the selective coupling mechanism comprises loops on each opposing end (the loops may comprise each lifting strap folded back onto itself and stitched into a loop) with an S-hook or the like used to couple the two loops together.

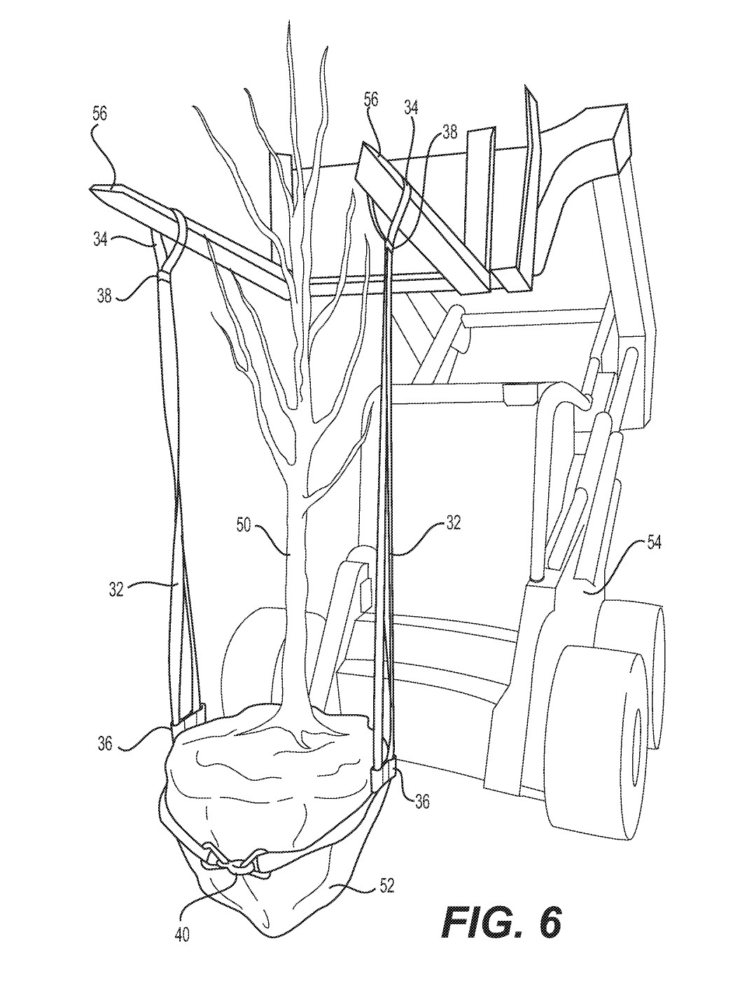

Referring now to FIGS. 4-6, in an alternative embodiment of the invention for lifting trees and other objects with a vertical obstruction, the lifting device 30 comprises a center loop 32 (the center loop may be considered to comprise opposing lifting straps, as illustrated), opposing side attachment points 34, transition points 38 between the center loop and side attachment points, and tightening elements 36. One of the lifting straps (the top one in FIGS. 4 and 5) has a selective coupling mechanism 40 located at or near its midpoint. In the illustrated embodiment, the selective coupling mechanism 40 comprises a stamped D-ring that is attached to the distal end of one of the sections of the lifting strap and a snap hook with D-ring that is attached to the distal end of the other one of the sections of the lifting strap. FIG. 6 illustrates the lifting device 30 used to lift a tree 50 by the root ball 52, using the forks 56 of a fork truck 54. Other than the selective coupling mechanism, the lifting device 30 is similar or identical in all other regards to the lifting device 10 describe above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A lifting device comprising:
first and second opposing straps, each strap having first and second ends, the first end of the first strap joined to the first end of the second strap forming a first end of a central loop, the second end of the first strap joined to the second end of the second strap forming a second end of the central loop;
first and second opposing lifting eyes, the first lifting eye at the first end of the central loop and joined to the first ends of the first and second straps, the second lifting eye at the second end of the central loop and joined to the second ends of the first and second straps; and
first and second opposing chokers, the first choker slidably engaged with the first and second opposing straps and selectively slidable in relation to the first and second opposing straps, the second choker slidably engaged with the first and second opposing straps and selectively slidable in relation to the first and second opposing straps, the first and second chokers being independently slidable.

2. The lifting device of claim 1, wherein the first opposing choker comprises a single loop slidably engaged with both the first and second opposing straps; and
wherein the second opposing choker comprises a single loop slidably engaged with both the first and second opposing straps.

3. The lifting device of claim 1, wherein the first opposing choker comprises first and second loops, the first loop slidably engaged with the first opposing strap and the second loop slidably engaged with the second opposing strap; and
wherein the second opposing choker comprises first and second loops, the first loop slidably engaged with the first opposing strap and the second loop slidably engaged with the second opposing strap.

4. The lifting device of claim 1, wherein the first opposing strap comprises separate first and second strap portions, each of the first and second strap portions having a free end; and
wherein the lifting device further comprises a selective coupling mechanism for selectively coupling the free end of the first strap portion to the free end of the second strap portion.

5. The lifting device of claim 4, wherein the selective coupling mechanism comprises a hook affixed to the free end of the first strap portion and a ring affixed to the free end of the second strap portion.

6. The lifting device of claim 4, wherein the free end of the second strap portion comprises a loop; and
wherein the selective coupling mechanism comprises a hook affixed to the free end of the first strap portion.

7. The lifting device of claim 4, wherein the free end of the first strap portion comprises a loop;
wherein the free end of the second strap portion comprises a loop; and
wherein the selective coupling mechanism comprises an S-hook.

8. A method of lifting comprising:
(a) providing a lifting device comprising:
(1) first and second opposing straps, each strap having first and second ends, the first end of the first strap joined to the first end of the second strap forming a first end of a central loop, the second end of the first strap joined to the second end of the second strap forming a second end of the central loop;
(2) first and second opposing lifting eyes, the first lifting eye at the first end of the central loop and joined to the first ends of the first and second straps, the second lifting eye at the second end of the central loop and joined to the second ends of the first and second straps; and
(3) first and second opposing chokers, the first choker slidably engaged with the first and second opposing straps and selectively slidable in relation to the first and second opposing straps, the second choker slidably engaged with the first and second opposing straps and selectively slidable in relation to the first and second opposing straps, the first and second chokers being independently slidable;
(b) engaging the first and second opposing lifting eyes with a lifting machine;
(c) placing the central loop around an object to be lifted;
(d) sliding the first and second opposing chokers toward the object to be lifted; and
(e) raising the lifting device via the lifting machine.

9. The method device of claim 8, wherein the first opposing choker comprises a single loop slidably engaged with both the first and second opposing straps; and
wherein the second opposing choker comprises a single loop slidably engaged with both the first and second opposing straps.

10. The method device of claim 8, wherein the first opposing choker comprises first and second loops, the first loop slidably engaged with the first opposing strap and the second loop slidably engaged with the second opposing strap; and
wherein the second opposing choker comprises first and second loops, the first loop slidably engaged with the first opposing strap and the second loop slidably engaged with the second opposing strap.

11. The method device of claim 8, wherein the first opposing strap comprises separate first and second strap portions, each of the first and second strap portions having a free end;
wherein the lifting device further comprises a selective coupling mechanism for selectively coupling the free end of the first strap portion to the free end of the second strap portion;
wherein the selective coupling mechanism is selectively decoupled prior to placing the central loop around an object to be lifted; and
wherein the selective coupling mechanism is selectively coupled after placing the central loop around an object to be lifted.

12. The method device of claim 11, wherein the selective coupling mechanism comprises a hook affixed to the free end of the first strap portion and a ring affixed to the free end of the second strap portion.

13. The method device of claim 11, wherein the free end of the second strap portion comprises a loop; and
wherein the selective coupling mechanism comprises a hook affixed to the free end of the first strap portion.

14. The method device of claim 11, wherein the free end of the first strap portion comprises a loop;
wherein the free end of the second strap portion comprises a loop; and
wherein the selective coupling mechanism comprises an S-hook.
